(19) United States
(12) Patent Application Publication
(10) Pub. No.: US 2013/0325482 A1
(43) Pub. Date: Dec. 5, 2013

(54) ESTIMATING CONGNITIVE-LOAD IN HUMAN-MACHINE INTERACTION

(71) Applicant: GM GLOBAL TECHNOLOGY OPERATIONS LLC, Detroit, MI (US)

(72) Inventors: Eli Tzirkel-Hancock, Ra'anana (IL); Omer Tsimhoni, Herzliya (IL)

(73) Assignee: GM Global Technology Operations LLC, Detroit, MI (US)

(21) Appl. No.: 13/761,541

(22) Filed: Feb. 7, 2013

Related U.S. Application Data
(60) Provisional application No. 61/652,587, filed on May 29, 2012.

(51) Int. Cl. G10L 21/18

(52) U.S. Cl. CPC G10L 21/18
USPC 704/275

(57) ABSTRACT

Estimating cognitive-load of a user in human-machine interaction by identifying an expression of cognitive-load within a user expression captured by a dialogue system and using a user model to estimate a level of the cognitive-load based on the expression of cognitive-load.

### CROSS-REFERENCE TO RELATED APPLICATION

This application claims priority under 35 U.S.C. §119(e) to U.S. provisional patent Application Ser. No. 61/652,587, filed May 29, 2012, and is incorporated herein by reference in its entirety.

### BACKGROUND OF THE PRESENT INVENTION

The present invention relates generally to dialogue-systems and, specifically estimating cognitive-load of users interacting with them. Cognitive-load may be considered a measure of mental stress experienced by the user and may be explicitly or inexplicitly expressed while interacting with the system. Estimation of cognitive-load during user interaction facilitates ascertaining, more accurately, true goals of the user. When implemented in vehicles of travel, such estimates may assist in ascertaining cognitive-load related driving activities.

Such systems are used in many different applications including, inter alia, automotive safety, telemetric systems used to service vehicles remotely, or infotainment activities facilitating the acquisition or the pursuit of recreational items of interests, in accordance to expressed intent during dialogue sessions. It should be appreciated that such systems and methods also have application in any vehicular settings including train and airplane travel, and amusement rides.

Typical driver-related activities that can cause cognitive-load in a driver include road-conditions, traffic conditions, passenger activities, driving comfort and ease of operation, driving or travel time, and driving experience.

### BRIEF DESCRIPTION OF THE DRAWINGS

The subject matter regarded as the invention is particularly pointed out and distinctly claimed in the concluding portion of the specification. The invention, however, in regards to its components, features, method of operation, and advantages may best be understood by reference to the following detailed description and accompanying drawings in which:

FIG. 1 is a schematic, block diagram of hardware employed in dialogue- systems, according to an embodiment of the present invention;

FIG. 2 is a schematic, block diagram of primary software modules employed in dialogue-system, according to an embodiment of the present invention;

FIG. 3 is a flow chart depicting a method employed by the system of FIGS. 1 and 2, according to an embodiment of the present invention;

FIG. 4 is a partial Bayesian network employed in the system of FIGS. 1 and 2 for statistically modeling the impact of cognitive load on user goal estimates; and

FIG. 5 depicts a non-transitory, computer-readable medium having stored thereon instructions for statistical modeling cognitive-load of a user interacting with a dialogue-system, according to an embodiment of the present invention.

It will be appreciated that for the sake of clarity, elements shown in figures have not necessarily been drawn to scale and reference numerals may be repeated in different figures to indicate corresponding or analogous elements.

### DETAILED DESCRIPTION OF THE PRESENT INVENTION

In the following detailed description, numerous details are set forth in order to provide a thorough understanding of the invention. However, it will be understood by those skilled in the art that the present invention may be practiced without these specific details. For the sake of clarity, well-known methods, procedures, and components are not described in detail.

The present invention is a dialogue-system operative to model cognitive-load of users interacting with the system.

The following terms will be used throughout this document:

“User action” refers to a user expression expressed in any modality or combination of modalities while interacting with a dialogue-system. The user action may include an explicit goal statement, a confirmation or a response to a machine-dialogue act, and an expression of cognitive-load.

The goal statement may be directed to performing an action, like booking reservations at a restaurant, or requesting information, or delivering information, for example

An expression of cognitive-load may be expressed as either disfluency embedded in a user action or as an explicit statement indicating cognitive-load, or a combination of both. Disfluencies are regional and time sensitive in that they reflect deviations from culture standards of expression that vary from one region to another and from one time period to another and therefore a disfluency in one region may not be considered a disfluency in another region, similarly, standards of expression also change with time and therefore, disfluencies are evaluated in the relevant social context. As noted, the present invention is operative in any of a variety of modalities of expression; verbal expression, physical contact, or through imagery.

Typical examples of verbal disfluencies include, inter-alia:
Mispronunciations
Truncated words or sentences in mid-utterance
Fillers of non-lexical vocables such as “uh”, “ehm” “well”, “err”, and “yea”
Fillers of lexical vocables such as “let's see”
Repetitions of words, phrases, or syllables,
Repaired utterances in which the speaker corrects his own slips of tongue
Extended pauses between words
Word substitution such as “How much . . . expensive is it?”
Articulation errors such as “Make a lift turn here.”
False starts like “Yes it's . . . actually it is . . . ”

Explicit statements indicative of cognitive-load include, inter alia, “Hang on”, “Hold on”, “Go on”, “Say that again”, “Please repeat”, “Go back”.

Examples of visual disfluencies include, inter-alia, facial gestures, and unusual hand motions that may be detected through an image capture system like tapping the steering wheel or dashboard.

Examples of disfluencies conveyed through physical contact include, inter alia, applying above normal pressure to the steering wheel, tapping the steering wheel or the dashboard with above predetermined standards of force or frequency, or applying a force to portion of a dashboard lacking a device actuator, like a switch or a button, or touching a touch screen on a portion lacking a virtual device actuator.

“User-dialogue-acts” refer to dialogue-system's understanding of user acts including any associated disfluency or statement indicative of cognitive-load in any modality or combination or modalities, according to embodiments. User-dialogue-acts are also referred to as “user-dialogue-actions” or “observation variables”. Understanding of user acts may be achieved via a speech or multimodal understanding system within the dialogue system.

“Machine-dialogue acts” refer to actions taken by a dialogue control module in any modality or combination of modalities based on a belief of the user goal, application of a policy, and other relevant parameters. Machine-dialogue acts are translated into machine acts by a machine-act generator, according to embodiments.

“Dialogue control module” refers to a component of the dialogue system applying a policy governing the interaction between a user and the dialogue system, as will be further discussed.

The present invention relates to human-machine dialogue-systems, and particularly, relates to dialogue-systems configured to model effects of cognitive-load, the cognitive-load may emanate from driving-related activities or from other sources.

Some human-machine dialogue systems are configured to statistically model user goals based on explicit input conveying to the system the user-acts. Embodiments of the present invention may also statistically model effects of cognitive-load generated from driving-related or other activities leading to accurate estimation of user goals.

In addition to manually operated vehicles, embodiments of the present system also have application in autonomous vehicles. The dialogue-system in these applications may evaluate a level of anticipated cognitive-load to be incurred by a driver if the autonomous driving is transferred to manual driving.

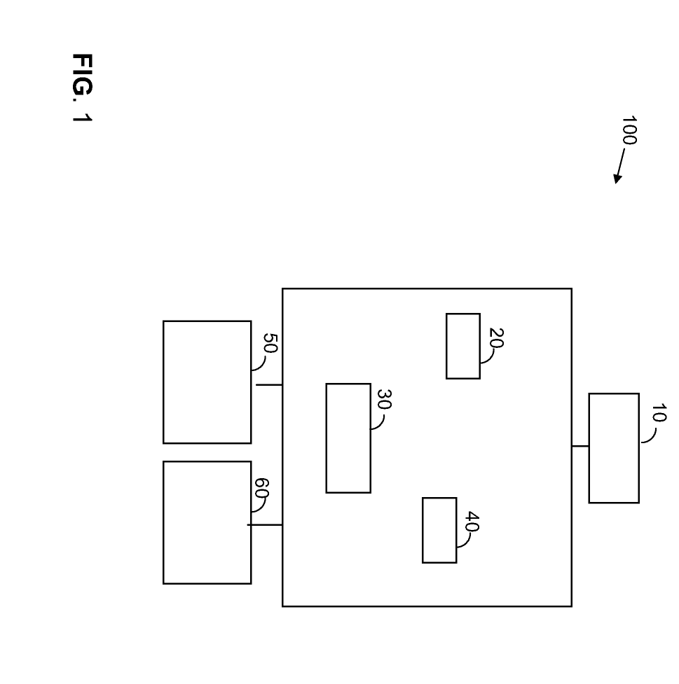

Turning now to the figures, FIG. 1 is a schematic diagram of a statistically-based multi-modal dialogue system according to an embodiment of the present invention.

Dialogue system 100 includes one or more processors or controllers 20, memory 30, long-term data storage 40, input devices 50, and output devices 60.

Processor or controller 20 includes a central processing unit or multiple processors. Memory 30 may be Random Access Memory (RAM), a read only memory (ROM). It should be appreciated that image data, code and other relevant data structures are stored in the above noted memory and/or storage devices.

Memory 30 includes, inter alia, random access memory, flash memory, or any other short term memory arrangement.

Long-term data storage devices 40 include, inter alia, a hard disk drive, a floppy disk drive a compact disk drive or any combination of such units.

Dialogue-system 100 includes, inter alia, one or more computer vision 10 sensors, digital camera, and video camera. Image data may also be may also be input into the dialogue system 100 from non-dedicated devices or databases.

Non-limiting examples of input devices 50 include, inter alia, audio capture and touch actuated input-devices including touch sensors disposed in proximity to other device actuator means like buttons, knobs, switches, and touch screens.

Non-limiting examples of output devices 60 include, inter alia, visual, audio and haptic feedback devices. It should be appreciated that according to an embodiment input devices 50 and output devices 60 may be combined into a single device.

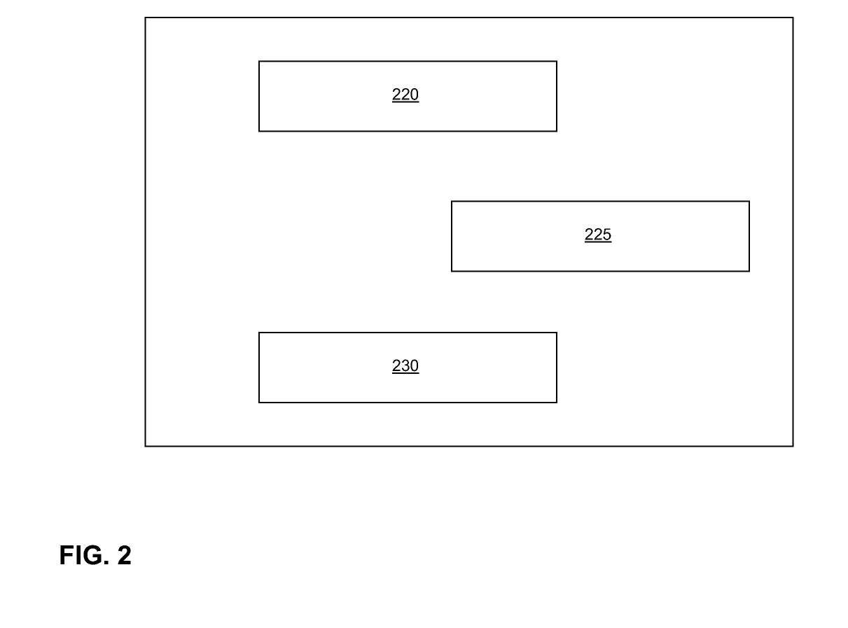

FIG. 2 depicts primary modules of a statistical, dialogue-system including an understanding module 220, a dialogue control module 225, and a machine-act generator module 230 according to embodiments of the present invention. Understanding module 220 is configured to identify user acts, from user expressions in dialogue with a dialogue-system according to embodiments of the invention. Either disfluencies, explicit user expressions indicative of cognitive-loads, or a combination of both may be included in the list of user acts identified, according to embodiments. The output of the understanding module 220 is a confidence scored list of user-dialogue acts, according to embodiments.

Dialogue control module 225 is configured to apply a user model including probability distributions of cognitive-load of the user and goals of the user and apply a policy to decide on an optimal system-dialogue-act for achieving the true goal of the user, according to an embodiment of the invention.

Machine-act generator 230 is configured to transform the system-dialogue-act into a machine-act, according to embodiments of the present invention.

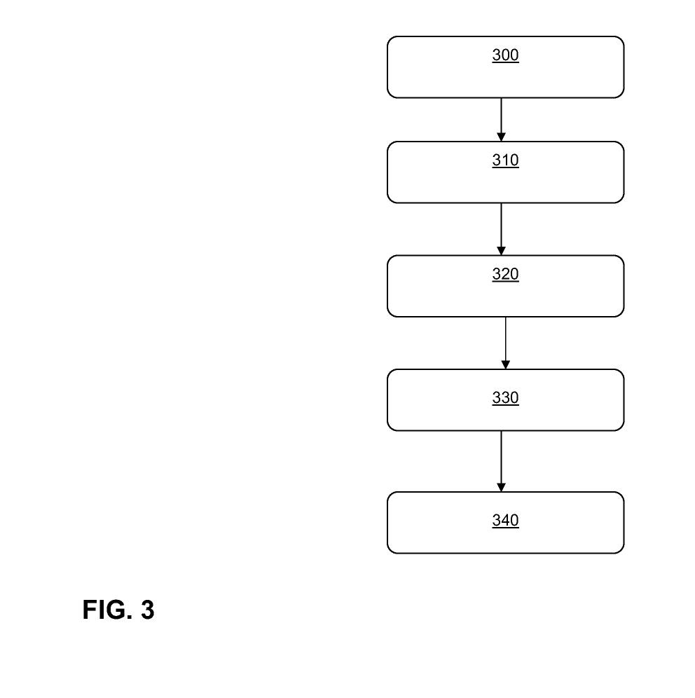

FIG. 3 depicts a flow chart of the primary steps involved in modeling cognitive-load of a user interacting with a dialogue system, according to embodiments of the present invention.

In step 300, a user expression is captured in any of the relevant modalities with the appropriate input device noted above.

In step 310, an understanding module identifies user dialogue acts including disfluencies, and statements indicative of cognitive load as noted above in an embodiment of the invention. Examples of verbal disfluencies include the above noted mispronunciations, truncations, lexical and non-lexical fillers, repetitions, repaired utterances, and extended pauses. These disfluencies may be recognized by a speech recognition system module and parsed by a semantic parser and passed on to a dialogue control module as part of a list of alternatives as will be further discussed.

Analogously, visual and disfluencies conveyed by touch may also be used as cognitive-load indicators as noted above.

Following is an example of a verbal disfluency expressed as a false start when requesting Chinese food:
“What is . . . where is Chinese food?”

Such a statement may be parsed as a user-dialogue act embedded with attributes for disfluencies or explicit expressions of cognitive load: For example; the above statement may be parsed as:
Inform (food=Chinese, disfluency=‘false Start’)
wherein, “Inform” is the type of user-dialogue act, “food” is an attribute, “food=Chinese” is an attribute value pair, “disfluency” is a second attribute, and “disfluence”=‘false start’ is a second attribute value pair. The presence of the attribute value pair “disfluency”=‘false start’ means that information regarding Chinese food was requested with a particular disfluency defined as a ‘false start’, according to a certain embodiment.

In a second example, a request for information about Chinese food in which the user explicitly asks for a time delay, by saying “Hang on” for example, may be parsed as:
Inform (food=Chinese, explicit=‘pause’).
   wherein the pause is embedded in the user-dialogue statement as an attribute value pair.

Additional attributes include, inter-alia, ‘resume’, ‘replay’, and ‘revert’.

After parsing, confidence scores are assigned to user-dialogue-acts determined to be most likely representing the user act, according to certain embodiments.

In step 320, a user model operative to model cognitive load using the user-dialogue-acts identified in step 310 and other factors, determines a goal list and associated probabilities, and optionally an estimate of cognitive-load. User models that may be employed include, inter alia, Bayesian networks, neural-networks, or any other model providing such functionality.

In step 330, a dialogue-system applies a policy to the resulting goal list to decide on a machine-dialogue-act according to an embodiment of the invention. The policy may be determined in advance from a learning process of the policy using dialogue success metrics, rewards, and interaction logs, in certain embodiments.

In step 340, a dialogue-system performs a system-dialogue act 340 based on the policy decision made in step 330 according to embodiments. Examples of machine-dialogue-acts include, inter alia, asking the user for more information, requesting verbal confirmation, redirecting a vehicle to a chosen location, playing chosen music, providing a form of haptic feedback, or any combination of the above.

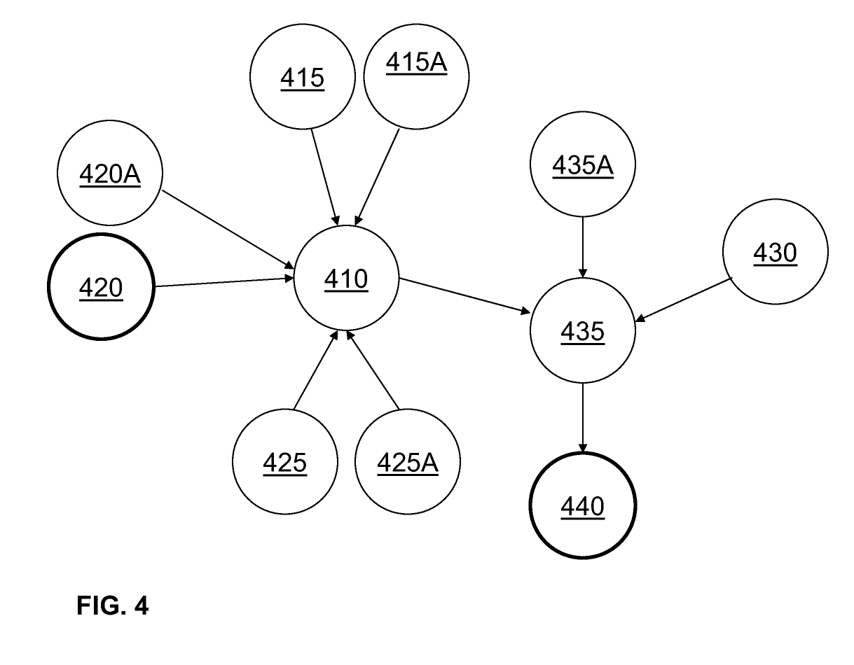

FIG. 4 depicts a partial dynamic Bayesian network, generally designated 400, modeling cognitive-load in human-machine interaction that may be employed in step 320 of FIG. 3.

Specifically, in each dialogue turn cognitive-load variable 410 is dependent on previous dialogue-turn variables; previous user goal 415 variable, previous machine-dialogue-act variable 420, and previous cognitive-load variable 425, in certain embodiments.

Furthermore, parameters of probability distributions representing dependency of the cognitive-load variable 410 on each of these variables are represented in nodes 415A, 420A, and 425A and, according to embodiments. Specifically, workload variable 410 depends on parameter 415A associated with previous user goal variable 415, on parameter 420A associated with observed machine-dialogue-act 420, and parameter 425A associated with cognitive-load 425. These parameters may be calculated using a data base of dialogue samples in a dedicated learning session. Dialogue samples of the present user may be used for learning; or dialogue logs of several users may be used at a leaning stage according to embodiments. Additionally, the parameters may be learned through expectation propagation, according to embodiments. Workload variable 410 may assume any of three levels of cognitive-workload; “low”, “medium”, and “high”, according to an embodiment of the invention.

Continuing with the dynamic Bayesian network, cognitive workload 410 may in turn be modeled as a casual dependency for user action 435 which in turn is modeled to be dependant on user goal 430 according to embodiments.

The dependency of user action 435 on the workload is also parameterized as represented by parameter 435A, as noted above.

User-dialogue-act 440 is an observation variable, or observed user-dialogue-act variable, and is modeled as being directly dependent on user action 435, in certain embodiments.

In operation, the cognitive workload 410 may be estimated through expectation propagation in the Bayesian network given the observed-variables 440 and 420, according to embodiments.

As an illustrative example of how casual dependencies can affect current cognitive- load, assuming that previous user goal 415, is work intensive, then there would be a correspondingly high conditional probability of the current cognitive workload 410 being dependent on previous user goal 415, in certain embodiments. For example, in a previous dialogue turn, a user goal of finding an unspecified piece of “rock” music from a very large selection can contribute to the current cognitive-load.

Likewise, a previous machine-dialogue-act 420 of displaying a long list of song titles for selection by the user can also affect the current cognitive-load 410. The previous cognitive-load of 425 can influence the current cognitive-load of node 410, in certain embodiments.

The user model of dependencies may be used to calculate a probability of user goals, using Bayesian expectation propagation network methods, according to embodiments of the invention. It should be appreciated that neural network models and other models providing such functionality may also be employed, according to certain embodiments.

Embodiments of the present invention also include provisions for estimating cognitive load based on data obtained from data-capture devices or systems non-related to the dialogue system. This may be accomplished by modeling such captured data as an additional observed node with appropriate dependencies in the Bayesian network model.

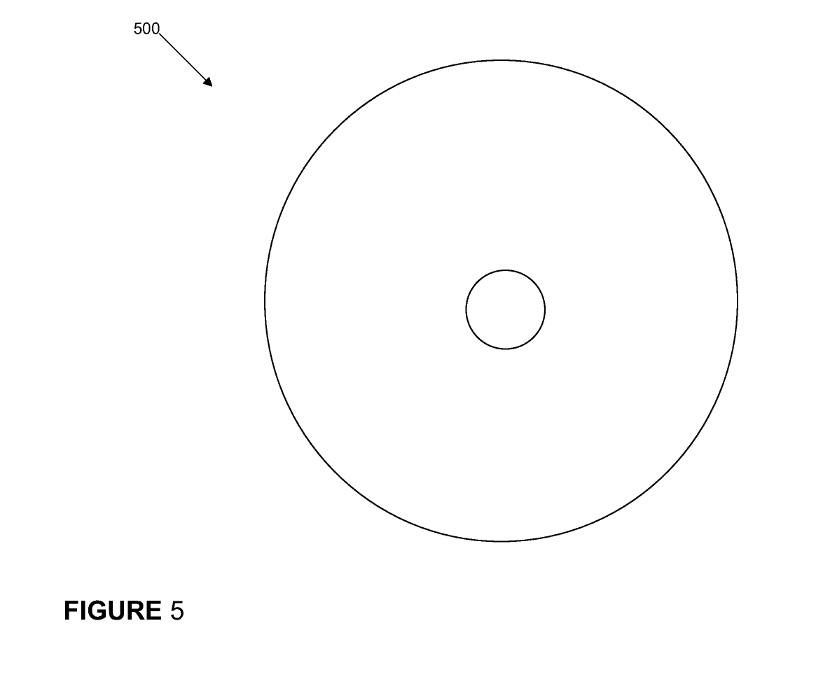

FIG. 5 depicts a non-limiting, computer-readable media containing executable code for configuring a computer system to execute the above described, cognitive-load enhanced dialogue system according to embodiments of the present invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for estimating cognitive-load through human-machine interface, the method comprising,
performing computer-implemented steps of:
identifying an expression of cognitive-load within a user expression expressed by a user interacting with a dialogue system; and
using a user model to estimate a level of the cognitive-load experienced by the user interacting with the dialogue-system based on the expression of cognitive-load.

2. The method of claim 1, wherein the user model includes a dynamic Bayesian network.

3. The method of claim 1, wherein the expression of cognitive-load is selected from the group consisting of disfluency, a statement indicative of cognitive-load, and disfluency combined with a statement indicative of cognitive-load.

4. The method of claim 2, wherein the dynamic Bayesian network includes an observed user-dialogue act variable depending directly or indirectly on a cognitive-load variable.

5. The method of claim 4, wherein the cognitive-load variable depends on at least one previous dialogue-turn variable.

6. The method of claim 5, wherein the previous dialogue-turn variable includes at least one of any of the previous dialogue-turn variables selected from the group consisting of previous cognitive-load variable, previous user-goal variable, and previous machine-dialogue-action variable.

7. The method of claim 1, wherein the user expression is selected from the group consisting of a verbal expression, a head motion, a facial expression, a hand gesture, and an application of pressure to a steering wheel wherein the pressure exceeds a threshold pressure.

8. The method of claim 1, wherein the dialogue system includes a multi-modal dialogue system.

9. The method of claim 1, wherein the dialogue system receives input from at least one data capture device non-related to the dialogue system.

10. The method of claim 1, further comprising selecting a system-dialogue act at least partially based on goal probabilities determined by the user model.

11. A dialogue system for estimating cognitive-load of a user interacting with the system, the system comprising:
a processor configured to:
recognize an expression of cognitive-load in a user expression captured by the dialogue system; and
use a user model to estimate a level of the cognitive-load experienced by the user at least partially based on the expression of cognitive-load.

12. The system of claim 11, wherein the user model includes a dynamic Bayesian network.

13. The system of claim 12, wherein the expression of cognitive-load is selected from the group consisting of a verbal disfluency, a statement indicative of cognitive-load, and a verbal disfluency combined with a statement indicative of cognitive-load.

14. The system of claim 12, wherein the dynamic Bayesian network includes an observed user-dialogue-act variable depending directly or indirectly on a cognitive-load variable.

15. The system of claim 14, wherein the cognitive-load variable depends on at least one previous dialogue-turn variable.

16. The system of claim 15, wherein the previous dialogue-turn variable is selected from the group consisting of previous cognitive-load variable, previous user-goal variable, and previous machine-dialogue-act variable.

17. The system of claim 11, wherein the dialogue system includes a multi-modal dialogue system.

18. The system of claim 10, wherein the dialogue system receives input from at least one data capture device non-related to the dialogue system.

19. A non-transitory computer-readable medium having stored thereon instructions for estimating cognitive-load of a user interacting with a dialogue system which when executed by a processor causes the processor to perform a method comprising:
recognizing an expression of cognitive-load in a user expression captured by a dialogue system; and
using a user model to estimate a level of the cognitive-load experienced by the user at least partially based on the expression of cognitive-load.

20. The non-transitory computer-readable medium of claim 19, wherein the user model includes a dynamic Bayesian network.
